(19) United States
(12) Patent Application Publication
(10) Pub. No.: US 2013/0239467 A1
(43) Pub. Date: Sep. 19, 2013

(54) METHOD OF EXTRACTING LIPIDS FROM TRAP GREASE WITH WASTE COOKING OIL

(71) Applicant: UNIVERSITY OF CINCINNATI, Cincinnati, OH (US)

(72) Inventors: Mingming Lu, Mason, OH (US); Jingjing Wang, Cincinnati, OH (US); Qingshi Tu, Cincinnati, OH (US)

(73) Assignee: UNIVERSITY OF CINCINNATI, Cincinnati, OH (US)

(21) Appl. No.: 13/835,236

(22) Filed: Mar. 15, 2013

Related U.S. Application Data
(60) Provisional application No. 61/611,326, filed on Mar. 15, 2012.

(51) Int. Cl. C11B 13/00; C10G 3/00

(52) U.S. Cl. CPC C11B 13/00; C10G 3/00
USPC 44/403; 554/21

(57) ABSTRACT

Describe are methods of extracting the lipid fraction from trap grease using vegetable oil, such as vegetable oils sourced from waste cooking oil. The method includes mixing a volume of vegetable oil with a volume of trap grease. The mixture is comprised of an aqueous fraction, a solid fraction, and a lipid fraction. The mixture is heated to a temperature in a range from about 50 degrees C. to about 100 degrees C. for a period of time sufficient to extract at least 80 percent of the lipids from the trap grease. The lipid fraction is then separated from the solid fraction. The method may further include a process of producing biodiesel from the extracted lipid fraction.

### RELATED APPLICATION

The present application claims the benefit of U.S. Ser. No. 61/611,326 filed Mar. 15, 2012, the disclosure of which is hereby incorporated herein by reference in its entirety.

### FIELD

The present invention is directed to methods of recycling fat, oil, and grease ordinance also referred to as trap grease and more particularly to methods of extracting lipids from trap grease.

### BACKGROUND

Trap grease refers to the mixture of lipids, water, and solid waste generated by many commercial operations, such as restaurants, and captured in a grease trap. The grease trap functions to separate the trap grease from waste water so that the grease does not reach public sewerage systems where it can accumulate causing flow restrictions that can cause flooding. Many communities regulate the processing and disposal of trap grease collected from commercial operations. These regulations typically require the trap grease to be regularly collected by professional grease haulers and disposed of at waste water treatment plants or landfills.

According to one estimate based on surveys of 30 U.S. metropolitan areas, about 13 pounds of trap grease are generated per person per year. Based on this estimate, 3 to 4 billion pounds of trap grease are generated every year in the United States alone. Disposing of this vast quantity of trap grease is expensive.

Trap grease includes a lipid fraction that may serve as a source of fuel, such as biodiesel, or that may be recycled for other uses. However, current processes for extracting the lipid fraction from trap grease consume high levels of energy to heat to distill the lipid components, use chemical solvents that increase the costs and difficulty in handling the extracted products or do not extract sufficient concentrations of lipid to be decanted from the other components in the trap grease. For example, the heating and filtration method produces an oil-like liquid from the trap grease but the amount of the oil-like liquid produced is not sufficient to form a separate liquid layer is difficult decant it the larger volume of solids and other liquid remaining after heating.

The solvent extraction method utilizing organic solvents extracts a higher percentage of the lipids in the trap grease but is disadvantageous. For example, organic solvents can be expensive and generally must be recovered from the extracted lipid requiring extra processing steps and special equipment to handle the solvents.

Methods of extracting the lipid fraction from trap grease in a manner that does not consume large amounts of energy and that does not require the use of expensive and difficult to handle solvents are needed.

### SUMMARY

Aspects of the invention are directed to extracting the lipid fraction from trap grease using vegetable oil, such as vegetable oils sourced from waste cooking oil. The advantages of using vegetable oil as the extraction agent for extracting the lipid fraction from trap grease include: vegetable oil solvents removes the need for a solvent recovery step in the extraction process; and vegetable oil may be used in the same downstream processes as the trap grease; and 3) vegetable can potentially help dilute the free fatty acid concentrations in the trap grease to a level acceptable to simplify the production of biodiesel from the lipids extracted from the trap grease.

An embodiment of the invention is directed a process of extracting the lipid fraction from trap grease with a vegetable oil. The process includes mixing a volume of vegetable oil with a volume of trap grease. The mixture is comprised of an aqueous fraction, a solid fraction, and a lipid fraction. The mixture is heated to a temperature in a range from about 50 degrees C. to about 100 degrees C. for a period of time sufficient to extract at least 80 percent of the lipids from the trap grease. The lipid fraction is then separated from the solid fraction.

Another aspect of the invention is directed to a process of producing biodiesel from trap grease that includes extracting the lipid fraction from the trap grease with a vegetable oil and processing the extracted lipids including the extracted vegetable oil to produce biodiesel. The biodiesel producing processing may include treating a portion of the lipid fraction with at least one of an acid esterification reaction or a transesterification reaction.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a graph demonstrating that the glycerides in the vegetable oil do not react with water to form free fatty acids.

FIG. 2A is a graph illustrating the time course for extracting free fatty acids from trap grease with vegetable oil over a range of vegetable oil to trap grease ratios in accordance with embodiments of the invention.

FIG. 2B is another graph illustrating the time course for extracting free fatty acids from trap grease with vegetable oil over a range of vegetable oil to trap grease ratios in accordance with embodiments of the invention.

FIG. 3 is a scatter plot demonstrating that free fatty extraction at room temperature is inefficient but heating the mixture to 85 degrees C. rapidly improves free fatty extraction.

FIG. 4 is a graph illustrating the effect of temperature on the extraction of free fatty acids from trap grease with vegetable oil in accordance with embodiments of the invention.

FIG. 5 is a graph demonstrating the effect of temperature on the efficiency of extraction over a range of vegetable oil to trap grease ratios.

### DETAILED DESCRIPTION

Embodiments of the present invention are directed to a process for extracting lipids from trap grease using plant oils. Further embodiments are directed to a process for preparing a biodiesel product from trap grease that includes the extraction of lipids from the trap grease with plant oils.

Trap grease refers to both the fats, oils, and grease (FOG) collected from grease traps of commercial food services and the FOG in waste water streams. Trap grease includes a lipid fraction, an aqueous fraction, and a solids fraction of non-extractable solids. The aqueous fraction generally makes up about 50 percent by weight to about 90 percent by weight of the trap grease mass. The solids fraction generally makes up about 5 percent by weight to about 25 percent by weight of the trap grease mass. The lipid fraction generally makes up about 5 percent by weight to about 25 percent by weight of the trap grease mass. The lipid fraction is primarily comprised of free fatty acids, but may also include minor amounts of glycerides.

Vegetable oil have previously been used as a non-traditional biodiesel feedstock. Vegetable oil is primarily comprised of glycerides with minor amounts of free fatty acids. A readily available source of vegetable oil that is useful in the methods described herein are vegetable oils. Vegetable oil generally refers to used cooking oils, like used vegetable oils. Other previously used sources of vegetable oil, as well as vegetable oil that has not previously been used may be used in embodiments of the invention. Exemplary vegetable oils useful for practicing the invention include canola oil, peanut oil, grape seed oil, rape seed oil, olive oil, and other similar vegetable oils that are liquid at room temperature.

Trap grease and vegetable oil are mixed. The ratio of vegetable oil (milliliters) to trap grease (grams) ranges from about 1:1 to about 5:1. In an embodiment, the ratio of vegetable oil to trap grease ranges from about 1.5:1 to about 4.5:1. In a preferred embodiment, the vegetable oil to trap grease ratio ranges from about 2.5 to about 3.5.

The mixture is stirred to create a slurry of the vegetable oil and the trap grease. The slurry includes a relatively homogenous mixture of the aqueous fraction, the lipid fraction, and the solid fraction. The mixture is heated to at least 50 degrees C. and preferable to a range from about 50 degrees C. to about 85 degrees C. In another embodiment, the mixture is heated to a range from about 60 degrees C. to about 85 degrees C. In yet another embodiment, the mixture is heated to a range from about 55 degrees C. to about 65 degrees C.

The mixture may be heated under moderate agitation to facilitate the mixing of the vegetable oil and the trap grease. In an embodiment, care is taken during while agitating to prevent the solid insoluble particles of the solids fractions from being ground into a particle size that is not easily separated from the extracted lipid fraction. For example, preferably the insoluble solid particles are not reduced to a size having a smallest diameter of less than about 100 micrometer. The mixture may be agitated by any method as known to one of ordinary skill in the art. For example, the mixture may be manually or mechanically mixed such as with a motorized paddle, a stir bar, a sonicator, or by rocking, rotating, or vibrating the reaction chamber, and combinations thereof.

The mixture is heated to the desire temperature for a period of time to extract at least 85 percent of the lipid fraction from the trap grease into the vegetable oil and preferably between about 90 percent and about 100 percent of the lipid fraction from the trap grease into the vegetable oil. In an embodiment, the mixture is also maintained as the desire temperature for a period of time sufficient to evaporate a majority of the aqueous fraction from the mixture, and preferably for a period time sufficient to evaporate almost all of the aqueous fraction from the mixture. In an embodiment, greater than 98 percent of the water is evaporated from the mixture. In an embodiment, the mixture is heated to the desired temperature for at least about 45 minutes and more preferably for a period of time of at least 60 minutes. The mixture may be heated to the desired temperature for a period of time from about 45 minutes to about 210 minutes. Generally, the amount of time required to complete the reaction is inversely proportional to the temperature at which the extraction is conducted. Put another, at higher temperatures, a shorter period of time is needed to complete the extraction as compared to extractions conducted at lower temperatures. For example, in an embodiment, the mixture is heated to a temperature of about 85 degrees for a period of about 45 minutes to about 90 minutes to extract between about 80 percent to about 99 percent of the lipid fraction. In another embodiment, the mixture is heated to a temperature of about 60 degrees for a period of about 45 minutes to about 90 minutes to extract between about 80 percent to about 99 percent of the lipid fraction. In another embodiment, the mixture is heated to a temperature of about 55 degrees for a period of about 90 minutes to about 180 minutes to extract between about 80 percent to about 99 percent of the lipid fraction. In another embodiment, the mixture is heated to a temperature of about 50 degrees for a period of about 180 minutes to about 210 minutes to extract between about 80 percent to about 99 percent of the lipid fraction. The mixture may be heated using routine methods as are known to those of ordinary skill in the art, such as heating the extraction vessel with steam or electrical heating elements. Care is taken to prevent the mixture from contacting an open ignition source that could ignite the lipid fraction.

After the prescribed period of time, the extracted lipid fraction is separated from the solid fraction. In one embodiment, the mixture is vacuum filtered with the solid fraction being collected on the filter side and the filtrate including the extracted lipids. The extracted lipids can be separated from the solid fraction by other methods such as by sedimentation and centrifugal separation as are known in the art of separating solids from liquids.

The collected extracted lipids include lipids from the vegetable oil and the lipid fraction from the trap grease. The collected extracted lipids are generally free of insoluble solids and water. The collected extracted lipids may be used as a feedstock for various oleo-chemical processes.

The present method is less energy intensive and expensive to practice than distillation processes and does not use solvents that must be recovered after the extraction. Indeed, the vegetable oil, while functioning as a solvent, is suitable for the same uses as the collected lipid fraction, i.e., collected fats, oils, and greases extracted from the trap grease. One such process is the production of biodiesel. Because the vegetable may be used in the same processes as the extracted lipids, a solvent recovery step is not utilized with the present method.

An aspect of the invention is directed to the production of biodiesel from trap grease. The method includes the process of extracting the lipid from the trap grease with a vegetable oil as described above. The extracted lipid fraction may then be used to produce biodiesel. Depending on the free fatty acid concentration of the extracted lipid fraction, the lipid fraction may be converted to biodiesel through one of two processes. If the free fatty acid concentration is up to about 5 percent, then the lipid fraction is converted to biodiesel directly with a transesterification reaction. If the free fatty acid concentration is greater than 5 percent, the lipid fraction is converted to biodiesel in a two-step process that includes an acid esterification reaction followed by a transesterification reaction.

Transesterification is a reaction between glycerides and methanol that produces biodiesel with glycerol as the by-product. The reaction may be catalyzed with a base, such as sodium hydroxide or potassium hydroxide in accordance with Formula (1) below.

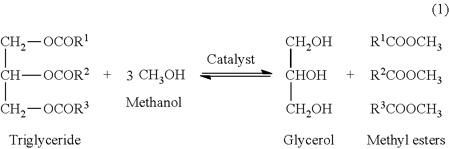

If the free fatty acid concentration in the lipid fraction is up to about 5 percent, the free fatty acids can be processed directly by the transesterification step, but extra alkali catalyst is needed to neutralize the free fatty acids as shown in Formula (2) below. The extra alkali catalyst is in the addition to the amount of alkali catalyst already present to catalyze the transesterification reaction. The extra alkali catalyst forms a soap from the free fatty acid that may be removed with a water-wash step.

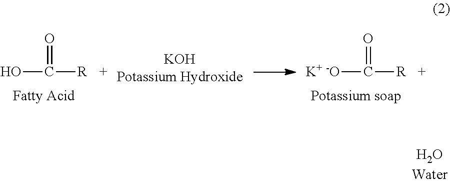

If the free fatty acid concentration is greater than about 5 percent, an acid esterification reaction is used to convert the free fatty acids to a methyl ester that may then be converted to biodiesel via the transesterification reaction.

Acid esterification utilizes methanol along with an acid catalyst, such as sulfuric acid, to convert free fatty acids in the extracted lipid fraction into biodiesel as shown in Formula (3) below. As the reaction between free fatty acids and methanol is reversible, an excess molar amount of methanol is used to shift the equilibrium toward the production of the methyl ester and water.

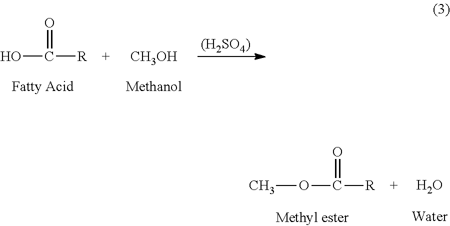

Contamination by the solid fraction in the trap grease can decrease the operating efficiency of these reactions. As such, extraction processes described herein are ideal for extracting the lipid fraction from trap grease for use to produce a biodiesel.

### Example

The lipid compositions in trap grease can include glycerides (tri-, di- and mono-) and free fatty acids. But as the percentage of glycerides in the trap grease is very low (generally about 0.21%), the present study looked to the variance of the amount of free fatty acids present in the vegetable oil during the extraction process to validate the inventive processes.

Titration was used to determine the amount of the free acids in the vegetable. For this study, waste cooking oil (“WCO”) was used as the source of the vegetable oil. The titration method used in this study was modified from the American Oil Chemists Society (“AOCS”) method Cd 3d-63. The AOCS method utilizes a large volume of solvent (i.e., 125 ml). In order to reduce the amount of the waste solvent generated in this study, the amount of the solvent used for this study was reduced to 50 mL.

The extraction samples were titrated with 0.1N of potassium hydroxide (KOH) solution with 50 ml of the mixture of isopropyl alcohol and toluene (1:1, volumetric ratio) as the solvent and 0.8 ml of 1% phenolphthalein as the indicator. WCO contains a relatively constant concentration of free fatty acids; thus, the WCO was titrated before being mixed with the trap grease to obtain the initial amount of the free fatty acids in the WCO, that is, the blank value. The mass of the free fatty acids and the free fatty acid content in the trap grease were calculated by using Equation (1) and (2) below, respectively.

$$Mass of FFAs = \frac{{C}_{KOH} * ( {V}_{KOH} - {V}_{b} )}{{V}_{S}} * {V}_{O} * M . W {.}_{FFA} \qquad ( 1 )$$

C_{KOH}—Concentration of KOH used for titration, 0.1 mole/L

V_{KOH}—Amount of KOH used for the titration of 2 mL of extraction sample, L

V_{b}—Blank value/Amount of KOH used for the titration of 2 mL of WCO before extraction, L

V_{S}—Amount of the sample, 2 mL

V_{O}—Amount of the WCO used as the solvent, mL

M. W._{FFA}—Average molecular weight of the FFAs, 273.32 g/gmole

$$FFA \% = \frac{Mass of FFAs}{{W}_{TG}} \times 100 \% \\ {W}_{TG} \text{-} Total weight of the MSD \text{-} TG used , g \qquad ( 2 )$$

Test of Hydrolysis

The high (>50%) water content in the trap grease can become a concern for the extraction process because glycerides, the main component of WCO, can react with water to form free fatty acids. It has been reported that after 70 hours of frying at the temperature of 190 degrees C. the free fatty acid level in fresh soybean oil increased from 0.04% to 1.51%. If during the extraction process, free fatty would be produced in this way, then the amount of free fatty acids obtained from the titration would be the sum of the free fatty acids extracted from the trap grease plus the free fatty acids produced via the hydrolysis process, which means the water must be eliminated before the extraction process.

For this analysis, water and WCO were added into a beaker at a volumetric ratio of 1:1 and the mixture were heated up in water bath. The temperature was maintained at 90 degrees C. for a desired period of time. Two trials were performed. Stirring was applied to one trial and the other one was performed without stirring. The samples were taken and titrated by KOH solution every 30 minutes.

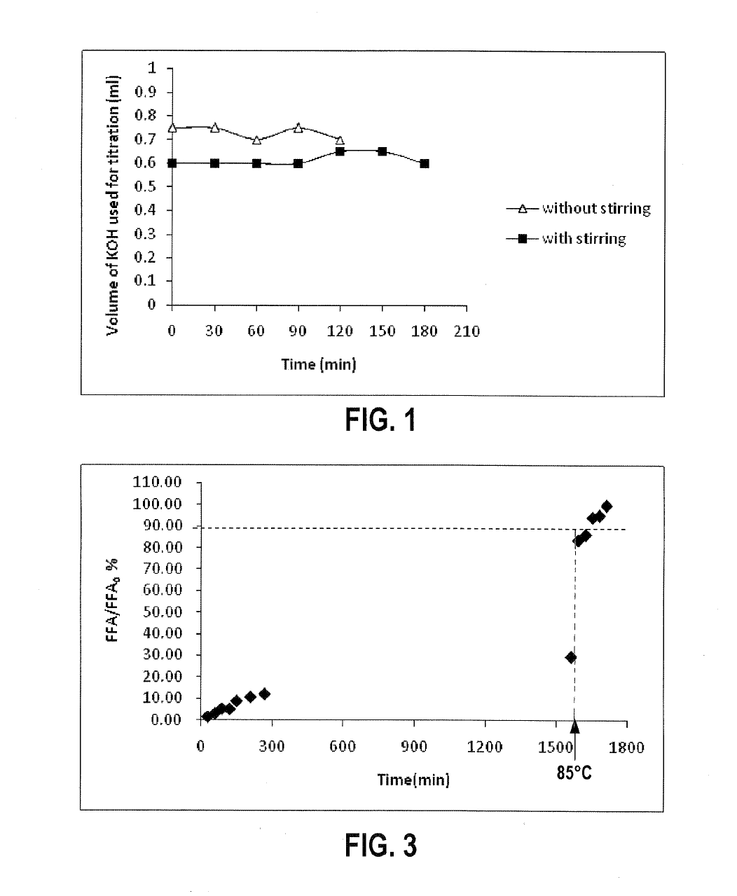

As illustrated in FIG. 1, the amount of KOH solution used for titration varies little with time and the difference is only 0.05 mL. The slight fluctuation might be caused by sampling and operational errors. This result illustrates that under the experimental condition of the extraction process for this study, glycerides do not react with water to form free fatty acids and the amount of the free fatty acids obtained from the titrations is the amount of the free fatty acids extracted from the trap grease samples.

WCO Dosage Estimates

The purpose of these experiments was to find a representative ratio of WCO to the trap grease to study the effect of temperature on extraction duration. These trial experiments were performed at different ratios of WCO (ml) to the trap grease sample (g), over a range from 1.5:1 to 4.5:1 with an increment increase in WCO of 0.5 over the range of ratios. This ratio system was used in considerations of the actual plant level operations: the WCO is measured by volume and the trap grease (solids) by the weight. A ratio of 2:1 represents 20 mL of WCO and 10 g of the trap grease. As the water in the trap grease sample was not eliminated beforehand, the weight of the trap grease in the ratio is the total weight. If the unit of the WCO was converted into gram, the ratio of 2:1 (ml/g) would be approximately 1.8:1 (g/g).

The WCO was preheated to 90 degrees C. The mixture of the WCO and the trap grease was heated in a water bath to maintain the extraction temperature at 85 degrees C. A 2 ml sample was take every 30 minutes until the free fatty acid concentration in the WCO reach a plateau. The mixture was stirred by hand for about 15 seconds once each hour during the study.

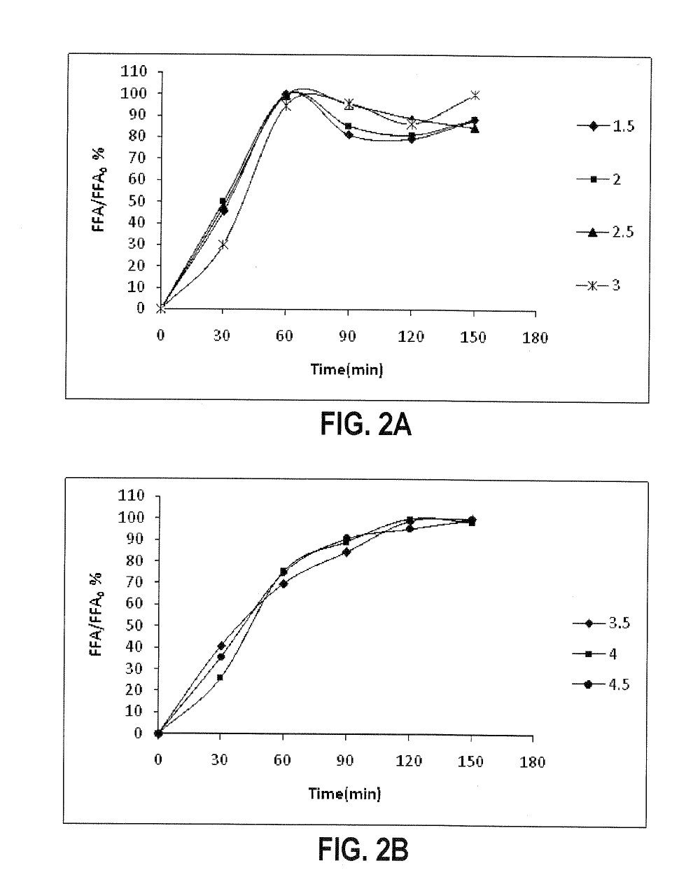

FIGS. 2A and 2B illustrate the extraction durations for different extraction ratios. According to the results, the extraction time was divided into two groups. For the extraction ratios, 1.5:1 to 3:1, the amount of the FFAs extracted from the trap grease reaches the maximum after one hour (FIG. 2A) and decreases afterwards. This can be partially explained by sampling and operational errors because for the amount of the WCO added to extract lipids from the trap grease was so small that most of the WCO was absorbed by the trap grease, thus it was collect a full volume same at every time point, especially the later time points.

For the larger ratios, 3.5:1, 4:1 and 4.5:1, the curves tend to level off after two hours of extraction (FIG. 2B). Compared with the larger ratios, it takes less time for the curves of the lower ratios to level off, which may indicate that the WCO is saturated by the FFAs after one hour of extraction for the lower ratios.

Based on these results and analysis, the ratio of WCO to trap grease chosen for further analysis was 3.5:1, which translates to a mass ratio of about 3.15:1, Higher ratios of WCO to trap grease did not show an improved performance over that observed with 3.5:1.

Effect of Temperature on Extraction Duration

The role of temperature plays in the extraction process was studied. A total of five temperatures were studied: 85 degrees C., 60 degrees C., 55 degrees C., 50 degrees C. and room temperature.

Preheated (if necessary) WCO was mixed with the trap grease samples at a ratio of 3.5:1 (ml/g). For example, for 10 g of the trap grease sample, 35 ml of WCO is added. The mixture was heated in water bath to maintain the desired temperature. Samples were taken every 30 minutes until the free fatty acid concentration in the WCO leveled out. The mixture was stirred by hand for about 15 seconds every 1 hour. Samples were titrated with KOH solution and the results were calculated as previously described.

Room temperature was studied for the reason that if the extraction would work well without heating, energy needed to heat the mixture could be saved. The extraction was allowed to proceed for 26 hours at room temperature, then the mixture was heated up to 85 degrees C. in a water bath. FIG. 3 illustrates that the extraction efficiency at room temperature is very low. After 26 hours of extraction at room temperature, only about one third of the extractible free fatty acids were extracted from the trap grease. However, once the temperature of the mixture was increased to 85 degrees C., indicated by the arrow and dashed line, the concentration of the free fatty acids in the WCO increased dramatically. Without heating, the extraction process may take several days to complete.

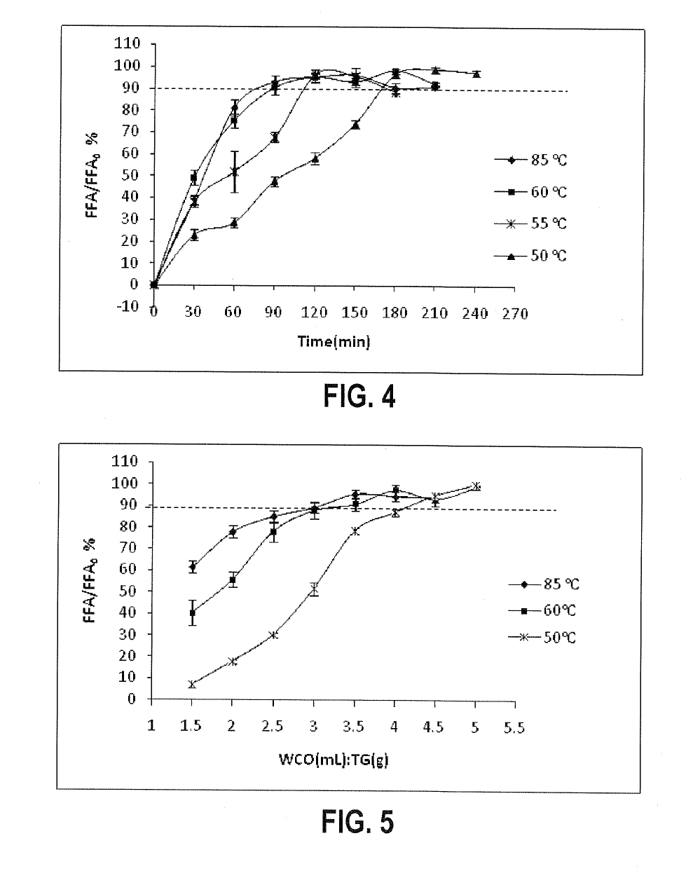

FIG. 4 illustrates the effect of a range of temperatures on the time required to complete the extraction of free fatty acids from the trap grease. The amount of time required to extract 90% of the free fatty acids decreases as temperature increases from about 50 degrees to about 55 and then to about 60 degrees. However, there are no significant differences in the extraction efficiency between 60 degrees and 85 degrees. The two curves tend to level off after about 90 minutes and at each sampling point and the percentage of free fatty acids extracted are very similar between the 60 degree C. and 85 degree C. samples. The extraction efficiency at 50 degrees C. and 55 degrees C. is less than the extraction efficiency at 60 degree C. and 85 degree C. At 55 degrees C., the extraction required about two hours to plateau above the 90 percent threshold. At 50 degrees C., the extraction does not reach a plateau above the 90 percent mark until after more than three hours. As a whole, the extraction efficiency increases significantly when the extraction process is carried out at elevated temperatures as compared to extractions conducted at room temperature.

Effect of Temperature on Extraction Ratio

The optimum extraction ratio may vary at different temperatures. To test this, the extraction over a range of ratios was tested at three temperatures, 85 degrees C., 60 degrees C. and 50 degrees C. The mixture ratios increase by increments of 0.5 from 1.5:1 (ml WCO: mg trap grease) to 5:1.

Preheated WCO was mixed with the TG and the mixture was heated up in water bath and was stirred by hand for about 15 seconds every one hour during the extraction process. Based on the results obtained from the study of the effect of temperature on extraction duration, at 85 degrees C. and 60 degrees C., for each ratio, samples were taken after two hours of extraction. At 50 degrees C., for each ratio, samples were taken after three hours of extraction. The samples were titrated by using KOH solution and the results were calculated as previously described.

As illustrated in FIG. 5, at 85 degrees C., the extractible free fatty acids in the trap grease samples were almost completely extracted at the ratio of 3.5:1. At 60 degrees C., the optimum extraction ratio was 4.1 and for 50 degrees C., the optimum extraction ratio was greater than 5:1. The higher the temperature, the lower the optimum ratio of WCO to trap grease. For 50 degree C., though the curve does not completely level off and appears to have the potential to increase after the ratio of 5:1, the study was discontinued because the difference in the extraction efficiency among the three test temperatures was already established. At 50 degrees, the required extraction time is longer and the required ratio is larger as well.

Filtration and Acid Esterification

After the extraction process, the solids were removed by vacuum with coffee filters. After filtration, the free fatty acid level in the WCO was high, usually varying from 5% to 8%. Acid esterification was employed to lower the free fatty acids level before transesterification.

The exact amount of free fatty acids in the WCO was determined by titration with KOH solution. The amount of methanol and that of the catalyst, sulfuric acid, were determined based on the amount of free fatty acids in the WCO, with a molar ratio of methanol to free fatty acids being 40:1 and a mass ratio of sulfuric acid to free fatty acids being 12.5:100. The extracted lipids were preheated before being mixed with the methanol and the sulfuric acid. The temperature was maintained at 60 degrees C. during the reaction. The top of the container was sealed with aluminum foil and Parafilm during the reaction to prevent the loss of methanol due to evaporation. Stirring was applied to this reaction to enable sufficient contact between the methanol and the WCO. The reaction lasted for about one hour.

After the reaction, the mixture was allowed to settle for about five hours in order to separate the methanol from the WCO. The methanol layer was removed and only the WCO layer went through transesterification process. This is because after the separation, the water formed in the reaction exists in the methanol layer and can be detrimental to the transesterification process. For this study, the water in the methanol layer may also come from the trap grease as the water in the trap grease was not eliminated before the extraction process.

Transesterification Process

Though the free fatty acid concentration in the extracted lipid after the acid esterification had already been lowered to an acceptable level, titration was still performed to make sure the extracted lipid was still suitable for the transesterification process since acid esterification is a reversible process.

For the transesterification process, sodium hydroxide (NaOH) was employed as the catalyst and methanol as the alcohol. For every 100 mL of extracted lipid, 0.35 g of NaOH was added as the catalyst. Additional NaOH was also added to neutralize the free fatty acids as determined by the titration. Methanol was added at a volumetric ratio of 1:5 (methanol to WCO). The reaction temperature was maintained at 60 degrees C. and stirring was used. The extracted lipid was preheated before being mixed with the methanol and the sodium hydroxide. The reaction lasted for about 15 minutes and the mixture was allowed to settle overnight to separate glycerol completely from biodiesel. After that, a separatory funnel was used to remove glycerol and to wash biodiesel until the pH of the drain-out water became 7. The product, biodiesel, was ready to use as a fuel.

These data indicate that under the conditions described herein, the lipid fraction from trap grease may be extracted with vegetable oil at an optimum temperature of about 60 degrees with respect to extraction time and vegetable oil dosage. The 85 degree temperature was effective as well but was considered less desirable because the extraction temperature was not significantly better than extraction at 60 degrees and the 85 degree extraction requires more heat energy to complete.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A method of extracting a lipid fraction from trap grease comprising:
mixing a volume of vegetable oil with a volume of trap grease, wherein the mixture is comprised of an aqueous fraction, a solid fraction, and a lipid fraction;
heating the mixture to a temperature in a range from about 50 degrees C. to about 100 degrees C. for a period of time sufficient to extract at least 80 percent of the lipids from the trap grease; and
separating a portion of the lipid fraction from the solid fraction.

2. The method of claim 1, wherein the vegetable oil is mixed with the trap grease at a ratio between about 1.5 ml:1 mg to about 4.5 ml:1 mg.

3. The method of claim 1, wherein the mixture of vegetable oil and trap grease is heated to a temperature in a range from about 55 degrees C. to about 85 degrees C.

4. The method of claim 1, wherein the mixture of vegetable oil and trap grease is heated to a temperature in a range from about 60 degrees C. to about 65 degrees C.

5. The method of claim 1, wherein the mixture of vegetable oil and trap grease is maintained at the desire temperature for a period of time from about 45 minutes to about 210 minutes.

6. The method of claim 1, wherein the separation step includes separating the lipid fraction from the solid fraction using a filtration process.

7. The method of claim 1, wherein the separation steps includes separating the lipid fraction of the mixture from an aqueous fraction of the mixture by heating the mixture for a period of time sufficient for at least a majority portion of the aqueous fraction to evaporate.

8. The method of claim 1 further comprising at least one of an acid esterification reaction or a transesterification reaction of the lipid fraction separated.

9. The method of claim 8, wherein the acid esterification reaction step includes mixing a volume of methanol and an acid with the extracted lipids under reaction conditions sufficient to form a methylester and water.

10. The method of claim 8, wherein the transesterification reaction step includes mixing a volume of methanol and a catalyst with the extracted lipids under reaction conditions sufficient to form glycerol and methyl esters.

11. The method of claim 8 further comprising separating at least one of water or glycerol from the product of the acid esterification reaction step or the transesterification reaction step.

12. A method of forming biodiesel from trap grease comprising:
mixing a volume of vegetable oil with a volume of trap grease, wherein the mixture is comprised of an aqueous fraction, a solid fraction, and a lipid fraction;
heating the mixture to a temperature in a range from about 50 degrees C. to about 100 degrees C. for a period of time sufficient to evaporate the aqueous fraction;
separating the solid fraction from a portion of the lipid fraction; and
treating the portion of the lipid fraction with at least one of an acid esterification reaction or a transesterification reaction.

13. The method of claim 12, wherein the vegetable oil is mixed with the trap grease at a ratio between about 1.5:1 to about 4.5:1.

14. The method of claim 12, wherein the acid esterification reaction step includes mixing a volume of methanol and an acid with the portion of the lipid fraction under reaction conditions sufficient to form a methylester and water.

15. The method of claim 12, wherein the transesterification reaction step includes mixing a volume of methanol and a catalyst with the portion of the lipid fraction under reaction conditions sufficient to form glycerol and methyl esters.

16. The method of claim 12 further comprising separating at least one of water or glycerol from the product of the acid esterification reaction step or the transesterification reaction step.
